(19) United States
(12) Patent Application Publication
(10) Pub. No.: US 2012/0160939 A1
(43) Pub. Date: Jun. 28, 2012

(54) Two-Step De-Icng Nozzle

(76) Inventor: Elo Svanebjerg, Tappernoje (DK)

(21) Appl. No.: 13/383,470

(22) PCT Filed: Jul. 17, 2009
(86) PCT No.: PCT/IB2009/053118

§ 371 Date: Mar. 19, 2012

(51) Int. Cl. B05B 1/00

(52) U.S. Cl. 239/589

(57) ABSTRACT

A nozzle for a spray gun comprises a fixed assembly and a displaceable assembly; the fixed assembly comprising a tubular nozzle housing (1) having an inlet end (2) connectable to a fluid supply, and having an outlet end (3) and a flow passage extending from the inlet end (2) to the outlet end (3), the displaceable assembly comprising a pressure regulating mechanism arranged in said flow passage at the outlet end (3) in order to control the nozzle pressure Said mechanism comprises a stem (6); a baffle (7) mounted for axial displacement on said stem (6) in said flow passage defining a nozzle gap (20) between said baffle (7) and the housing (1). The fixed assembly further comprises means (12) to distribute a passing fluid flow and to support a second end (6b) of the stem and the means are fixed inside the housing (1), said means (12) further being adapted to fixedly receive a valve cone (5) connectable to an axially displaceable fluid supply tube (8) for supplying a fluid. First biasing means (10) adjust the maximum baffle displacement at a first flow rate interval and second biasing means (14) supplement said first biasing means (10) at a second flow rate interval, counteracting additional fluid pressure on the baffle (7).

The invention relates to the field of spray guns, wherein a fluid is fed from a fluid supply to the gun via a supply tube in a slideable connection with a valve cone in said spray gun, wherein the tube in a position of rest is forced into closing contact with the valve cone and allow a fluid flow into the spray gun as it is retracted from such contact in applications using high-viscous fluids e.g. chemicals mixed with polymers problems may arise if the fluid is exposed to excessive mechanical stress. Keeping a relatively low nozzle pressure has solved these problems. However, low nozzle pressure would also mean a low flow rate and usually a low spray length.

Very often the same spray gun will be used for a wide selection of fluids comprising both sensitive fluids and more robust fluids, and such a scenario does by no means create an optimal use.

### THE PRIOR ART

U.S. Pat. No. 5,312,048 describes a firefighter's spray gun, wherein a nozzle for a stream of fluid comprises a tubular body having an inlet end operable to be attached to a fluid supply hose, the fluid having a supply pressure, said body further having an outlet end and a flow passage through said tubular body from said inlet end to said outlet end, and a pressure regulating mechanism mounted in said body in said flow passage and at said outlet end, said mechanism comprising a baffle mounted for movement on said body and in said flow stream and separated from said body by a gap, biasing means connected between said body and said baffle and acting to reduce the size of said gap.

The prior art nozzle has solved a problem of a variations in the fluid supply pressure faced by firefighters. The prior art nozzle comprises features to change the size of the gap and to change the effective area acted upon by the flow of fluid in order to switch between a normal supply pressure condition and a low supply pressure condition, said switching requiring a short stop and manual adjustment.

When using a spray gun for fluids, some of which may not tolerate a nozzle pressure over a certain limit, said gun would be adapted to keep a low nozzle pressure even if the spray gun is also used with other fluids where higher nozzle pressures are not a problem. Consequently, the user would rather use two different guns to obtain an optimal situation.

This problem leads to a need for a spray gun capable of being used with at least two fluids having different requirements to the allowable nozzle pressures experienced in the spray gun.

### SUMMARY OF THE INVENTION

According to the invention the problem is solved by a method of providing a nozzle letting through a fluid flow and having two consecutive nozzle pressure levels, and a nozzle for a spray gun and adapted for use of said method, wherein said nozzle demonstrates the ability to maintain two different levels of nozzle pressure depending on the actual fluid flow rate, preferably following a generally straight line at each pressure level and a steep gradient between such levels. This flow rate/nozzle pressure relation develops automatically as the flow rate increases, and it becomes possible to keep a nearly constant first pressure level, as the flow rate increases to a first maximum flow rate, then the nozzle pressure will take a steep increase as the flow rate increases slightly until a nearly constant second nozzle pressure is reached and maintained for a second interval of flow rates.

The problem described is especially known from carrying out winter procedures on airplanes in need of being de-iced and anti-iced before a next take-off.

In airports the airplanes are usually subjected to a two step winter procedure including:
a first step of de-icing an airplane
a second step of anti-icing an airplane shortly before take-off.

Two different qualities of fluid are being sprayed from a de-icing station, preferably a de-icing vehicle, and due to the anti-icing fluid being a mixture of chemicals and polymers, said fluid would only tolerate a nozzle pressure no higher than about 4 bar, while the fluid used in the first step for de-icing purposes is not affected by the nozzle pressure, and a level of about 10 bar would be very productive for de-icing.

De-icing of airplanes is performed in order to remove ice and snow from the surface of an airplane by directing a strong jet of heated fluid e.g. a mixture of water and glycol having a low viscosity against the surface. Preferably, the flow rate is approximately 190-2501/min at a nozzle pressure of about 10 bar.

Next step would comprise an anti-icing treatment of the airplane with a heated thickened fluid having a high viscosity of about 20,000-30,000 cSt. The high viscosity results from admixing polymers creating long chains of molecules that are easily degraded due to mechanical stress, if exposed to elevated nozzle pressures.

A de-icing vehicle is very often equipped with only one spray gun, meaning that only a compromised solution may be obtained, which could result in a fairly high flow rate for both fluids.

According to the invention the method provides a nozzle, wherein a displaceable assembly allows a valve body or baffle to travel, in two sequences and in a controlled manner, away from a valve seat of a fixed assembly, and forming a gap therebetween defined by the rate of said fluid flow; the first sequence covering a first flow rate interval wherein first biasing means apply a force on a downstream side of the baffle in order to counterbalance a force applied on the upstream side of the baffle by the fluid flow, thereby maintaining a nearly constant first pressure level in said gap, until the baffle comes to a halt, and the second sequence covering a second flow rate interval wherein second biasing means apply a force on the displaceable assembly including the baffle, in order to counterbalance further increase of the flow rate by allowing further increase of the size of the gap, thereby maintaining in said gap a higher nearly constant second pressure level, while between said sequences the pressure in the gap is building up fast from the first level to the second level due to the increasing flow rate and the baffle maintaining an almost steady position relative to said valve seat.

The nozzle of the invention is generally known from the prior art cited but is adapted for use of the method mentioned above, said nozzle being able to receive fluid passing through a fixed nozzle assembly from a connectable inlet end of a tubular nozzle housing through a flow passage to an outlet end forming a valve seat, said nozzle housing receiving a displaceable assembly therein, the displaceable assembly is displaceable relative to cooperating support means of the fixed assembly and includes a pressure regulating mechanism comprising a baffle restricting the outlet end by forming a restriction or gap for the fluid flow between said valve seat and said baffle, the size of the gap varies with the distance of the baffle, and comprising first and second biasing means, respectively counterbalancing the flow rate continuously, wherein the first biasing means applies a first spring force to the baffle resulting in an increasing gap size and a nearly constant level of gap pressure, and the second biasing means applies a second spring force to the baffle supplementing the first force and resulting in a further increase of gap size and a higher nearly constant level of gap pressure.

The pressure regulating mechanism further comprises a stem supporting initial axial displacement of the baffle until reaching a stop defining the end of the first flow rate interval, and by the stem being supported in stem support means the baffle can be moved together with the stem sliding with an end inside the support means, whereby the gap size increases further in a second flow rate interval.

In an advantageous embodiment of the invention, the spring force of the first biasing means is provided by a compression spring mounted on a first end of the stem and being pre-compressed between the baffle and an inner bottom of the first spring housing, the spring force of the first spring being determined by the position of the spring housing along the stem thereby setting the nozzle pressure at the first flow rate interval; and wherein the spring force of the second biasing means is provided by another compression spring mounted on the second end of the stem and confined in the support means between an enlarged end of the stem and a shoulder inside the support means, said piston stem being hollow in order to ventilate a cavity in the support means, thereby allowing the stem together with the baffle to move outwards of the support means and thereby to increase the gap.

The nozzle according to the invention provides an automatic functionality whereby one and the same nozzle can be used optimally for both qualities of fluids, because of the way the two biasing means supplement each other over a very wide flow rate interval comprising a first interval generating a nearly constant first nozzle pressure and a second interval generating a nearly constant but higher nozzle pressure with an intermediary steep gradient leading from the first pressure level to the second pressure level.

The functionality of the nozzle works this way: first the fluid supply is allowed access through the inlet opening of the valve housing, passing through distribution and stem supporting means onwards to a baffle, which is spring-biased against said housing. The constant increase of the flow rate forces the baffle away from the housing in sync with the first compression spring. Having reached contact with a stop device retained on the stem, the maximum travel of the baffle along the supporting stem is reached. Now the flow rate by increasing even further will compress the second biasing means while the enlarged head of the piston stem carries the baffle further away from the valve housing revealing a still larger gap between the baffle and the housing. Said larger gap allows further increase of the flow rate, while the nozzle pressure stabilises at a second nearly constant pressure. Accordingly, what is invented is an automatic nozzle keeping a constant low pressure for the benefit of sensitive fluids at a well-defined first flow rate interval, while simply increasing the flow rate to a second flow interval, when using a non-sensitive fluid, will result in a higher constant pressure, as the second biasing means gradually gives in.

Consequently, the nozzle according to the invention does not require any manual readjustment in order to replace one fluid for another irrespective of the viscosities. All adjustments to accommodate the fluid selected are made by adapting to the proper flow rate interval.

Preferably, the enlarged head and the piston stem are in one piece in order to be cheaply manufactured.

In one embodiment of the invention the baffle is at least partly surrounding the first end of the piston stem and is mounted to freely slide on the stem in axial direction.

Moreover, the first biasing means will preferably comprise a first compression spring applying a spring force to the downstream side of the baffle and resting between the baffle and the inner bottom of said housing. Said spring force is determined by the position of the spring house along the stem and a stop nut maintaining said position and thereby setting the nozzle pressure at the first flow rate interval.

Further, the adjusting means controlling the travel of the baffle comprise, in addition to the stop nut, a counter nut locking said stop nut in a desired position along the stem, said nuts being in threadable connection with the stem.

The position of the stop nut along the piston stem defines a maximum size of a gap between the baffle and the nozzle housing, and consequently the maximum flow rate allowed in a first flow rate interval.

Preferably, the piston stem is hollow and ventilates a cavity between the valve cone fixed in the stem support means and the upstream end of the stem, and the second biasing means are activated as the flow rate exceeds a threshold value and enters a second flow rate interval, whereby the stem gradually slides out of the stem support means increasing the size of the gap.

The first flow rate interval is determined by a selection of fluids, which are not durable over a pressure level at which the characteristics of a fluid passing through a nozzle are damaged, and thereby also damaging the viscosity of said fluids.

In a preferred application of the invention the fluid is an anti-icing chemical and the allowable flow rates are preferably in a first interval of 40-130 l/min and guaranteeing a nearly constant first nozzle pressure over the nozzle gap of 2-4 bar, which are not detrimental to the known anti-icing fluids.

In another preferred application the fluid is any de-icing chemical and the flow rate is preferably in a second interval ranging 190-250 l/min and guaranteeing a nearly constant second nozzle pressure over the nozzle gap amounting to about 10 bar.

A spray gun provided with a nozzle according to the invention preferably has the outlet end of the nozzle housing connected to an outer mantle to be shifted in axial direction defining different spray patterns of the fluid exiting the gap by redirecting the flow.

### DRAWINGS

The foregoing and other objects and advantages of the invention will become apparent from the following detailed description in conjunction with the accompanying drawing, wherein:

FIG. 1 is a sectional view of the nozzle according to the invention, in a position of rest

FIG. 1A is a sectional view as seen in direction A-A in FIG. 1,

FIGS. 2A and 2B are sectional views of a fixed nozzle assembly and a displaceable stem assembly, respectively

FIG. 3 is a sectional view of the nozzle according to the invention, in a situation during a first flow rate interval

FIG. 4 is a sectional view of the nozzle according to the invention, in a situation during a second flow rate interval, and

FIG. 5 is a nozzle pressure/flow rate graph according to the invention.

### DETAILED DESCRIPTION

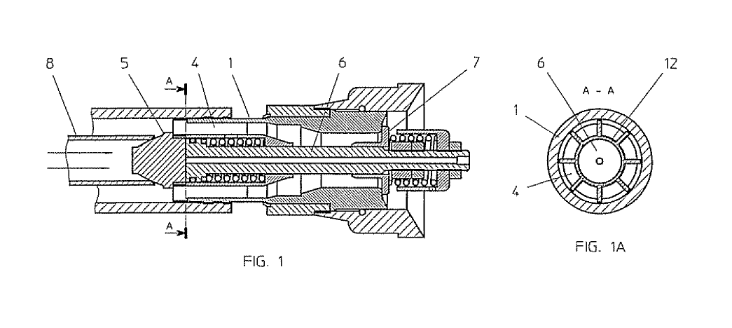

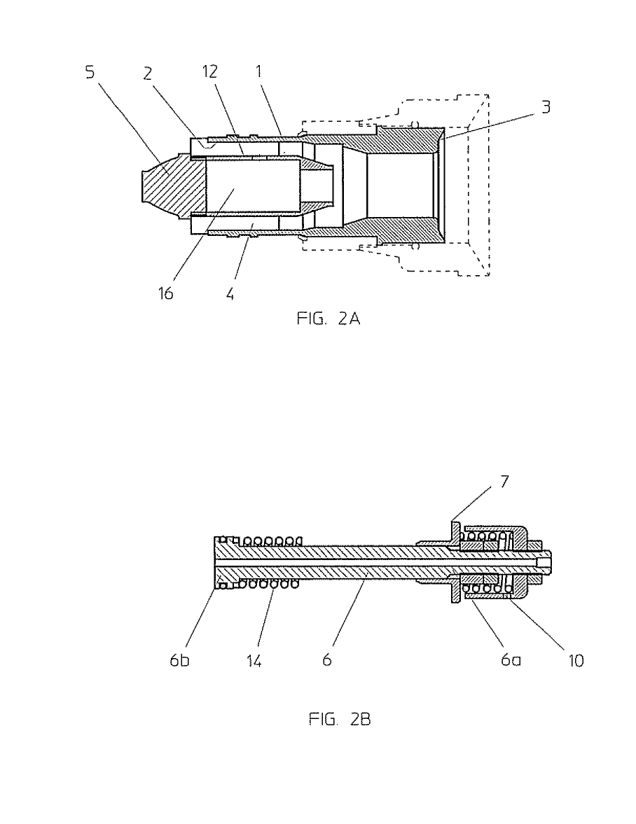

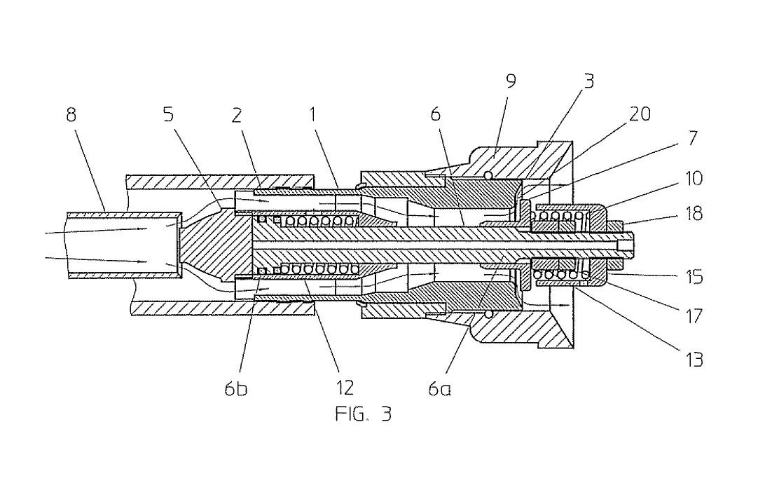

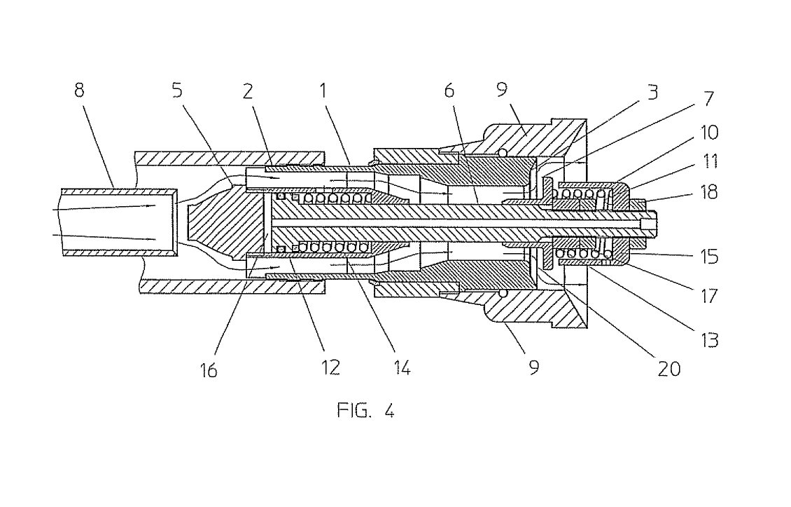

Referring to FIGS. 1 and 2 the nozzle according to the invention is shown in a position of rest and in an exploded view, respectively, and is comprised of generally a fixed assembly and a displaceable assembly, whereof the fixed assembly comprises a tubular nozzle housing 1 having an inlet end 2 connectable to a fluid supply, and an outlet end 3 and a flow passage extending from the inlet end 2 to the outlet end 3. The displaceable assembly comprises a pressure regulating mechanism arranged in said flow passage at the outlet end 3 in order to control the nozzle pressure. Said mechanism comprises a stem 6; a baffle 7 mounted for axial displacement on the stem 6 in said flow passage, defining (with reference to FIG. 3) a nozzle gap 20 between said baffle 7 and the housing 1; first biasing means 10 attached to a first end 6a of the stem 6 to counteract movement of the baffle 7 away from its position of rest against the nozzle housing 1, wherein the gap 20 is closed; and adjusting means 13, 17 to adjust the maximum baffle displacement at a first flow rate interval. The fixed assembly further comprises means 12 to distribute a passing fluid flow and to support a second end 6b of the stem 6, said means being fixed inside the nozzle housing 1, said supporting means 12 further being adapted to fixedly receive a valve cone 5 being connectable to an external, axially displaceable fluid supply tube 8 for supplying a fluid. Displacing the tube 8 to the left as seen in FIG. 1 releases the tube 8 from the valve cone 5, thereby releasing also a fluid flowing from a fluid supply to the outlet end 3 of the housing 1.

The nozzle according to the invention allows a fluid flow to pass through distributed channels 4 along the periphery of the support means 12 and inside of the housing 1. The fluid flow applies pressure on the upstream side of the baffle 7, which again transfers the force to the first biasing means in the form of a compression spring 10 so that the gap 20 opens gradually until the baffle 7 gets in contact with a stop nut 13 kept locked by a counter nut 17. The end of the first spring 10 opposite the baffle 7 bears on the bottom 11 of a first spring housing 15, and the spring force is determined by the position of the first spring house 15 along the stem 6 and a stop nut 18 maintaining said position and thereby setting the nozzle pressure at the first flow rate interval.

Having reached contact with the stop nut 13, the baffle 7 has come to the end of its journey along the stem 6 and the end of the first flow rate interval.

By increasing the flow rate further the nozzle pressure will follow a steep gradient until a second biasing means 14 gives in to the additional force applied to the baffle 7 and allows the displaceable assembly shown in FIG. 2B to move axially in downstream direction thereby increasing the gap 20 in sync with the increase in flow rate and stabilizing the nozzle pressure at a constant higher level at a higher second flow rate interval. This situation is depicted in FIGS. 3 & 4, wherein the enlarged second end 6b of a hollow stem 6 has slid piston-like outwards of the support means 12 and left a free cavity 16 between the valve cone 5 and said second end 6b of the stem 6, equal to the travel of the baffle 7 relative to the nozzle housing 1.

In a preferred embodiment of the invention the outlet end 3 of the nozzle housing 1 is provided with an outer mantle 9 to be shifted in axial direction defining different spray patterns of the fluid exiting the gap 20 by redirecting the flow. Such shifting of the mantle 9 being performed as need may arise.

Connecting the fluid supply to the nozzle according to the invention is done by any ordinary means known per se.

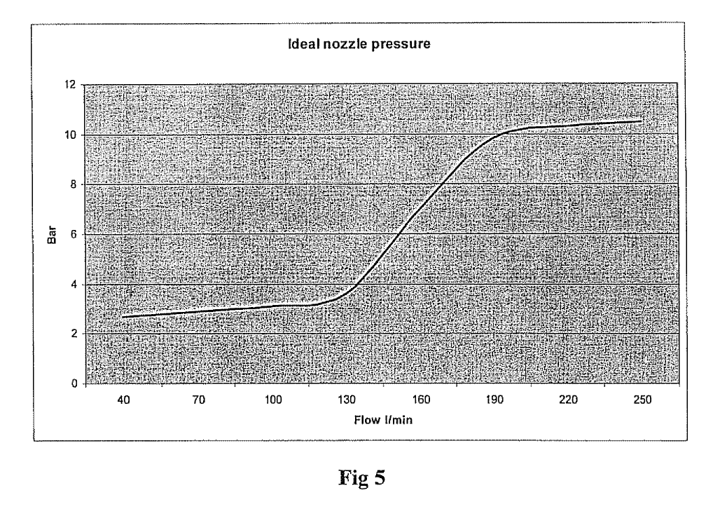

The fact that a nozzle according to the invention possesses an automatic functionality means that a spray gun with such nozzle could be used with any type of fluid irrespective of the nozzle pressure once the nozzle is adjusted to the two pressure levels required. Safeguarding fluids with high viscosities is obtained in an easy way by simply keeping the flow rate within a first flow rate interval. The relation between flow rates and nozzle pressures appears from FIG. 5 showing an almost constant pressure level of 2-4 bar at a first flow rate interval of 40-1301/min, followed by a steep gradient until the second constant pressure level of about 10 bar is reached at a second flow rate interval of 190-250 l/min. The two flow rate intervals differ significantly from each other.

1. Method of providing a nozzle designed to letting through a fluid flow and having two consecutive nozzle pressure levels, wherein a displaceable assembly allows a valve body or baffle to travel, in two sequences and in a controlled manner, away from a valve seat of a fixed assembly, and forming a gap therebetween defined by the rate of said fluid flow; the first sequence covering a first flow rate interval wherein first biasing means apply a force on a downstream side of the baffle in order to counterbalance a force applied on the upstream side of the baffle by the fluid flow thereby maintaining a nearly constant first pressure level in said gap, until the baffle comes to a stop; the second sequence covering a second flow rate interval wherein second biasing means apply a force on the displaceable assembly including the baffle, in order to counterbalance further increase of the flow rate by allowing further increase of the size of the gap, thereby maintaining in said gap a higher nearly constant second pressure level, while between said sequences the pressure in the gap is building up fast from the first level to the second level due to the increasing flow rate and the baffle maintaining an almost steady position relative to said valve seat.

2. Nozzle for a spray gun and adapted for use of the method according to claim 1, said nozzle being able to receive fluid passing through a fixed nozzle assembly from a connectable inlet end of a tubular nozzle housing through a flow passage to an outlet end forming a valve seat, said nozzle housing receiving a displaceable assembly therein, the displaceable assembly is displaceable relative to cooperating support means of the fixed assembly and includes a pressure regulating mechanism comprising a baffle restricting the outlet end by forming a restriction or gap for the fluid flow between said valve seat and said baffle, the size of the gap varies with the distance of the baffle and first and second biasing means, respectively counterbalancing the flow rate continuously, wherein the first biasing means applies a first spring force to the baffle resulting in an increasing gap size and a nearly constant level of gap pressure, and the second biasing means applies a second spring force to the baffle supplementing the first force and resulting in a further increase of gap size and a higher nearly constant level of gap pressure.

3. The nozzle according to claim 2, wherein the pressure regulating mechanism further comprises a stem supporting initial axial displacement of the baffle until reaching a stop defining the end of the first flow rate interval, and by the stem being supported in stem support means the baffle can be moved together with the stem sliding with an end into the support means, whereby the gap size increases further in a second flow rate interval.

4. The nozzle according to claim 2, wherein the spring force of the first biasing means is provided by a compression spring mounted on a first end of the stem and being pre-compressed between the baffle and an inner bottom of the first spring housing, the spring force of the first spring being determined by the position of the spring housing along the stem thereby setting the nozzle pressure at the first flow rate interval; and wherein the spring force of the second biasing means is provided by a compression spring mounted on the second end of the stem and confined in the support means between an enlarged end of the stem and a shoulder inside the support means, said piston stem being hollow in order to ventilate a cavity in the support means, thereby allowing the stem together with the baffle to move outwards of the support means and thereby to increase the gap.

5. The nozzle according to claim 4, wherein the enlarged head and the piston stem are in one piece.

6. The nozzle according to claim 2, wherein the baffle is at least partly surrounding the first end of the piston stem and in sliding engagement with said end.

7. The nozzle according to claim 2, wherein said nozzle further comprises adjusting means controlling the travel of the baffle; a stop device delimiting the downstream journey of the baffle; a counter nut able to retain the stop device in a desired position along the stem and the stop device and the counter nut can be in threadable connection thereon.

8. The nozzle according to claim 2, wherein the stop device via its position along the piston stem defines a maximum size of the gap and consequently the maximum flow rate allowed in a first flow rate interval.

9. The nozzle according to claim 8, wherein the piston stem is hollow and ventilates the cavity defined between a closure or valve cone in the stem support means and the upstream end of the stem, and wherein the second biasing means is activated, as the flow rate exceeds a first maximum value and enters a second flow rate interval, whereby the stem gradually slides outwards of the support means increasing the size of the gap.

10. The nozzle according to claim 2, wherein the first flow rate interval is determined by a selection of fluids to be used, which are not durable over a pressure rate damaging the characteristics of a fluid passing through a nozzle, and thereby damaging the viscosity.

11. The nozzle according to claim 10, wherein the selected fluid is an anti-icing fluid and the allowable flow rates are preferably in a first interval ranging 40-130 l/min and safeguarding a nearly constant first nozzle pressure over the nozzle gap.

12. The nozzle according to claim 2, wherein the fluid is any de-icing chemical and the flow rate is preferably in a second interval ranging 190-250 l/min and guaranteeing a nearly constant second nozzle pressure over the gap.

13. The nozzle according to claim 11, wherein the first nozzle pressure is lower than the second nozzle pressure; preferably a first nozzle pressure of 2 to 4 bar and a second nozzle pressure of about 10 bar.

14. The nozzle according to claim 2, wherein the outlet end of the nozzle housing is provided with an outer mantle to be shifted in axial direction defining the spray pattern of the fluid exiting the gap.
